(19) United States
(12) Patent Application Publication
(10) Pub. No.: US 2022/0345306 A1
(43) Pub. Date: Oct. 27, 2022

(54) Symmetric Encryption Key Generation Using Wireless Physical Layer Information Without Sharing Any Information Pertinent To The Key

(71) Applicant: Drexel University, Philadelphia, PA (US)

(72) Inventors: Cem Sahin, Philadelphia, PA (US); Kapil R. Dandekar, Philadelphia, PA (US)

(21) Appl. No.: 17/720,610

(22) Filed: Apr. 14, 2022

Related U.S. Application Data
(63) Continuation of application No. 16/851,182, filed on Apr. 17, 2020, now abandoned.
Application No. 16/851,182 is a continuation of application No. 15/560,507, filed on Sep. 22, 2017, now abandoned.
(60) Provisional application No. 62/139,418, filed on Mar. 27, 2015.

(51) Int. Cl. H04L 9/08; H04L 9/14

(52) U.S. Cl. CPC H04L 9/0875; H04L 9/14; H04L 2209/80

(57) ABSTRACT

Symmetric keys are generated by an algorithm that uses the randomness from the wireless PHY layer to extract the keys. When used with reconfigurable antennas, the algorithm yields longer keys. By using the randomness from the wireless PHY layer, the algorithm solves the issue of secure information leakage to the wireless channel during key establishment phase. The algorithm also omits transmitting anything secure during this phase and prevents any intruder from obtaining information related to the key. This approach can automatically secure the communications over open wireless networks (those without authentication or encryption) or closed wireless networks using other methods of authentication.

### CROSS-REFERENCE TO RELATED APPLICATIONS

The present application claims priority to U.S. Provisional Patent Application No. 62/139,418, filed Mar. 27, 2015. The content of that application is herein incorporated by reference in its entirety.

### GOVERNMENT RIGHTS

The subject matter disclosed herein was made with government support under awards ECCS-1028608 and CNS-1228847 awarded by the National Science Foundation. The Government has certain rights in the herein disclosed subject matter.

### TECHNICAL FIELD

The invention relates to symmetric key generation techniques for wireless encryption and, more particularly, to wireless encryption techniques used in wireless routers, base stations, wireless cards, and the like where the wireless physical layer information is used to generate the wireless encryption key automatically without sharing any information pertinent to the key.

### BACKGROUND

Strong encryption is required to protect sensitive information being transmitted during online transactions. Symmetric encryption keys have been used in a majority of the security algorithms including RC4 and AES, which is also used as a part of the widely adopted WPA2 standard. The symmetric keys rely heavily on pseudorandom number generators and initialization vectors. However, in recent years, it has been proven by Lenstra et. al., “Ron was wrong, whit is right,” Tech. Rep., 2012, that the symmetric keys used currently lack the optimal randomness. Combined with the vulnerabilities resulting from holes in cryptographic algorithms, the reduced secrecy rate has led to major problems in the past (see, for example, A. Stubblefield, et al., “A key recovery attack on the 802.11b wired equivalent privacy protocol (wep),” ACM Trans. Inf. Syst. Secur., vol. 7, no. 2, pp. 319-332, May 2004. [Online]. Available: http://doi.acm.org/10.1145/996943.996948).

The technique described herein relies on the channel state information (CSI) obtained from the wireless channel between these two users. Although extracting secret keys based on CSI has been shown in the past, there has been a lack of discussion on key agreement on both ends of the link. For example, Mehmood, et al. in “Key establishment employing reconfigurable antennas: Impact of antenna complexity,” Wireless Communications, IEEE Transactions on, vol. 13, no. 11, pp. 6300-6310, November 2014, leverage pattern diversity introduced by reconfigurable antenna elements; however, they do not guarantee an agreement on a symmetric key. Unless the transmitter and the receiver agree on the same key before they commence their communication, they will not be able to transmit information that the receiver can understand, thereby making the above algorithms nothing more than just theoretical calculations with no practical application. A new technique for generating symmetric encryption keys is desired that can generate highly randomized symmetric encryption keys in reliance upon such channel state information.

### SUMMARY

The invention relates to a technique for generating symmetric keys for two wireless users at a transmitter and a receiver from wireless physical (PHY) layer information. Generating symmetric keys from the PHY layer relies on the reciprocal channels between two wireless nodes. The wireless channel itself is a great source of randomness that is not dependent on pseudorandom number generators. This feature comes from the environment (e.g. surrounding walls, buildings, people walking, etc.). In an ideal environment, the forward channel (from transmitter to receiver) is the same as the backward channel (from receiver to transmitter). However, due to multipath and other variations in the environment, this is rarely the case, which adds a challenge to extracting symmetric keys using PHY layer techniques.

The inventors' findings indicate that the PHY layer encryption key generation techniques are not able to guarantee symmetric keys for both sides of the communication. This is due to slight variations between the forward and the backward channel. The inventors propose an algorithm that overcomes this problem and extracts symmetric keys for wireless communication between two nodes. The algorithm uses the wireless channel as its source of randomness. The algorithm also reduces the information leaked (e.g. nonces, salts, etc.) to the unprotected (unencrypted), shared wireless medium during the key establishment phase. The algorithm also removes any need for initialization vectors, which have been proven to be susceptible to intelligent attackers (see Stubblefield et al. article referenced above). In operation, a transmitter and receiver implementing the encryption key generation techniques of the invention simply send dummy data back and forth and look at the underlying channel state information (CSI), which is independent of the data sent, and is instead a function of the surrounding environment. The general trend of the CSI is then used to generate the symmetric encryption keys.

In an exemplary embodiment, the algorithm establishes symmetric encryption keys using an independent source of randomness, which is the channel state information (CST) obtained from Orthogonal Frequency Division Multiplexing (OFDM) based wireless protocols (e.g. WiFi, 4G LTE, WiMAX). The algorithm not only generates a key without using a pre-known initialization vector (IV), but also provides agreement on the same key on both sides of the link without broadcasting any information related to the key (e.g. nonces, salts, IV). The methods described herein also leverage reconfigurable antennas to augment the strength of the keys. In such a configuration, each mode of the reconfigurable antenna adds length to the key.

Exemplary embodiments of the invention include methods and wireless access points having an algorithm loaded into a processor to implement such methods for generating symmetric encryption keys from channel state information. In particular, a method of generating symmetric encryption keys in accordance with the invention includes the steps of wirelessly sending data, preferably dummy data, between a transmitter and a receiver to generate channel trend information representative of channel state information collected from forward and backward channels; repeating the process of sending data between the transmitter and receiver to generate channel trend information for each data subcarrier; and using the channel trend information for each data subcarrier for use in generating symmetric encryption keys or as the symmetric encryption keys themselves. In particular embodiments, the algorithm includes the steps of determining, for each data subcarrier, for successive channel state information data collected from forward and backward channels, whether an increase or decrease in magnitude from the previous measurement is observed for each data point and, if so, assigning a first value for an increase in magnitude and a second value for a decrease in amplitude. 2N measurements of channel state information are collected to form the channel trend information, where N is an integer greater than 0. The algorithm then repeats the steps of determining, for each data subcarrier, for successive CSI data collected from forward and backward channels, whether an increase or decrease in magnitude from the previous measurement is observed for each data point and, if so, assigning a first value for an increase in magnitude and a second value for a decrease in amplitude to provide 2N−1 sets of the first values and the second values. The algorithm then determines the most agreed upon bit value and assigns the most agreed upon bit value as a key bit for a pseudorandom generator. The algorithm may also repeat the steps of determining the most agreed upon bit value and assigning the most agreed upon bit value as the key bit for all of the data subcarriers to yield a key with length equal to a number of data subcarriers being used for the wireless transmission between the transmitter and the receiver.

In other exemplary embodiments, at least one of the transmitter and receiver includes a reconfigurable antenna, which yields longer keys. In this embodiment, the channel trend information for each data subcarrier for each mode of each reconfigurable antenna is used to generate symmetric encryption keys or as the symmetric keys themselves.

Once the symmetric encryption keys have been generated, the method further includes the steps of initiating transmission using the generated symmetric keys, determining whether acknowledgements are not received or a non-acknowledgement has been received at least three times back to back, and, if so, repeating the symmetric key generation step until a valid symmetric key is established. Alternatively, the transmitter may receive acknowledgements for all packets from the transmitter that the receiver is able to decrypt without issues and receive non-acknowledgements for all packets from the transmitter that the receiver received and was unable to decrypt. The transmitter may then determine whether acknowledgements were lost or non-acknowledgements have been received at least three times back to back, and, if so, repeat the symmetric key generation step until a valid symmetric key is established.

These and other characteristic features of the invention will be apparent to those skilled in the art from the following detailed description.

### BRIEF DESCRIPTION OF THE DRAWINGS

Exemplary embodiments of the invention will be described in conjunction with the associated figures, of which:

FIG. 1 illustrates a transmitter/receiver pair implementing Algorithm 1 for symmetric key generation.

FIG. 2 illustrates a transmitter/receiver pair using at least one reconfigurable antenna and implementing Algorithm 2 for symmetric key generation.

### DETAILED DESCRIPTION OF ILLUSTRATIVE EMBODIMENTS

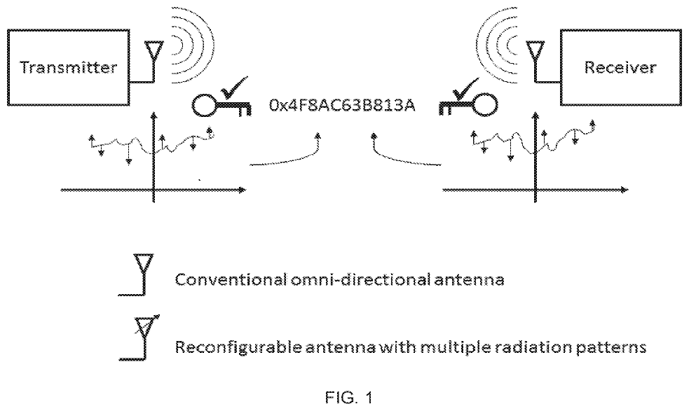

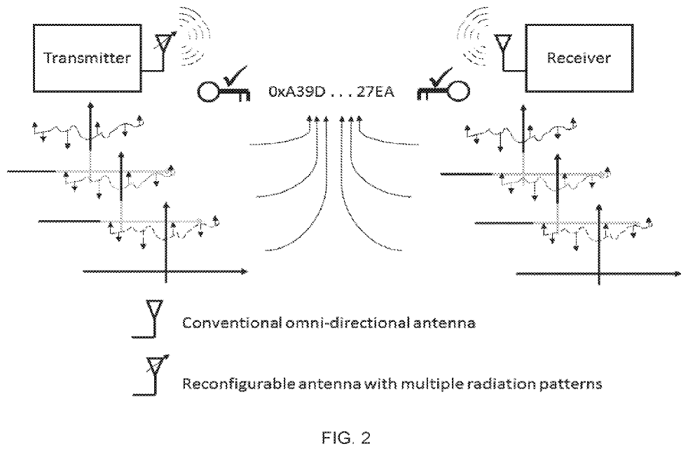

Certain specific details are set forth in the following description with respect to FIGS. 1-2 to provide a thorough understanding of various embodiments of the invention. Certain well-known details are not set forth in the following disclosure, however, to avoid unnecessarily obscuring the various embodiments of the invention. Those of ordinary skill in the relevant art will understand that they can practice other embodiments of the invention without one or more of the details described below. Also, while various methods are described with reference to steps and sequences in the following disclosure, the description is intended to provide a clear implementation of embodiments of the invention, and the steps and sequences of steps should not be taken as required to practice the invention.

To explain the methodology of the invention, the inventors set up a design using two Software-defined Radio (SDR) nodes using Orthogonal Frequency Division Multiplexing (OFDM) based 802.11 WiFi packets, with 48 data subcarriers. In the prior art (see, for example, S. Mathur, et al., “Radio-telepathy: Extracting a secret key from an unauthenticated wireless channel,” in Proceedings of the 14th ACM International Conference on Mobile Computing and Networking, ser. MobiCom '08. New York, N.Y., USA: ACM, 2008, pp. 128-139. [Online]. Available: http://doi.acm.org/10.1145/1409944.1409960), normalization, averaging, and thresholding are used to generate a key. However, such prior art algorithms fail when there are differences between the forward and the backward channel caused by the environment that is independent from the communication link. In order to cancel out the effects of this difference, the inventors have developed an algorithm that looks at the general trend observed by the CSI measurements. The general trend data is referred to herein as Channel Trend Information (CTI). The inventors look at successive CSI data collected from forward and backward channels and play the game of “higher or lower?” for each data subcarrier. For each data point, where an increase in magnitude from the previous measurement is observed, the inventors assign a 1, and a 0 for the opposite case. Of course, other values besides 0 and 1 may be used for the same purpose. In order to make the algorithm more robust, the inventors collect 2N number of CSI measurements to form the CTI, where N is an integer greater than 0. The inventors then play the same game, which provides 2N−1 sets of ones and zeros (or other value pairs). The algorithm then looks for the most agreed upon bit to finalize its decision on assigning a 1 or a 0 (or two other predesignated values) as the key bit for a pseudorandom generator or other means for generating symmetric encryption keys or the output of the algorithm may be used as the symmetric encryption key itself. This is repeated for all of the data subcarriers, which yields a key with length equal to the number of data subcarriers being used in the wireless standard. FIG. 1 illustrates a transmitter/receiver pair implementing such an algorithm for symmetric key generation. Algorithm 1 below shows in pseudocode the scheme explained in this paragraph.

Algorithm 1
Extracting Symmetric Keys
from Wireless PHY Layer

| | |
|---|---|
| 1: | procedure generateSymmetricKey(N) |
| 2: | C ← length of data subcarriers |
| 3: | key[0 to C−1] ← 0 |
| 4: | CTI[0 to 2N−1][0 to C−1] ← 0 |
| 5: | start: |
| 6: | for i ← 0, 2N − 1 do /** Obtain CSI and save it to CTI array **/ |
| 7: | send packet with dummy data to the other node |
| 8: | receive packet with dummy data from the other node |
| 9: | CTI[i][0 → C − 1] ← abs(CSI measurement) |
| 10: | for i ← 0,C − 1 do /** Play the game **/ |
| 11: | temp ← 0 |
| 12: | for j ← 1, 2N − 1 do |
| 13: | if CTI┌j┐┌i┐ > CTI┌j − 1┐┌i┐ then temp temp +1 |
| 14: | if temp >= N then key[i] ← 1 |
| 15: | elsekey[i] ← 0 |
| 16: | checkKeyStrength(key) /** Ensure key is strong **/ |
| 17: | if key is strong then |
| 18: | return key |
| 19: | else |
| 20: | go to start |

The scheme defined in Algorithm 1 provides more robust symmetric keys. However, Algorithm 1 matches the data subcarrier count to the length of the key. In the case of WiFi OFDM packets, only 48 data subcarriers are present. Algorithm 1 would then only be able to provide a key of 48-bits length, which is too short to provide strong encryption. Such a key could be vulnerable to brute force attacks.

In order to provide a longer key, the inventors also propose to leverage reconfigurable antennas (RA), where the different radiation patterns obtained by the multiple available modes on the antenna allow the inventors to observe multiple realizations of the wireless channel. The inventors then concatenate these realizations to provide a longer key that is not repeated. In the past, concatenating multiple CSI measurements from an omnidirectional antenna has been tried and, due to the repeated nature of the resulting key, a loss in randomness was observed. Algorithm 2 shows pseudocode explaining an extension to Algorithm 1 using Reconfigurable Antennas. FIG. 2 illustrates a transmitter/receiver pair implementing Algorithm 2 for symmetric key generation.

Algorithm 2
Extracting Enhanced Symmetric Keys from Wireless
PHY Layer using Reconfigurable Antennas

| | |
|---|---|
| 1: | procedure generateSymmetricKeyWithRA(N,M) |
| 2: | M defined as number of modes available on the RA |
| 3: | C ← length of data subcarriers |
| 4: | key[0 to M*C−1] ← 0 |
| 5: | CTI[0 to 2N−1][0 to M*C−1] ← 0 |
| 6: | start: |
| 7: | for i ← 0, 2N − 1 do /** Obtain CSI and save it to CTI array **/ |
| 8: | for j ← 0,M − 1 do /** for each mode of the reconfigurable |
| | antenna **/ |
| 9: | send packet with dummy data to the other node |
| 10: | receive packet with dummy data from the other node |
| 11: | CTI[i][0 + j * C → C − 1+ j * C] ← abs(CSI measurement) |
| 12: | for i ← 0,M * C − 1 do /** Play the game **/ |
| 13: | temp ← 0 |
| 14: | for j ← 1, 2N − 1 do |
| 15: | if CTI[j][i] > CTI[j − 1][i] then temp ← temp +1 |
| 16: | if temp >= N then key[i] ← 1 |
| 17: | elsekey[i] ← 0 |
| 18: | checkKeyStrength(key) /** Ensure key is strong **/ |
| 19: | if key is strong then |
| 20: | return key |
| 21: | else |
| 22: | go to start |

Algorithm 2 benefits from the increased number of modes available on a given Reconfigurable Antenna. By way of example, for an antenna with 7 modes, applying Algorithm 2 above with this antenna would increase the key length to 7*48=336 bits. The output of the algorithm could be used as the symmetric keys themselves or applied to a pseudorandom generator or other means for generating symmetric encryption keys.

In order to use the above algorithms in a practical manner, the inventors further propose an overall network protocol as described in Algorithms 3 and 4 below. The purpose of these algorithms is to demonstrate how a new wireless user joining a wireless network can start their communication in a secure manner. The inventors show the functionality intended for both the receiver and the transmitter for clarity. The inventors propose to start sending dummy data, which could be any wireless packet that does not contain important information. The inventors leave the freedom to select the contents of these packets to Wireless card or access point developers. If the number of packets sent is a vital statistic (e.g. for bandwidth limited customers in cellular data communications), it may be allowed to use these initial packets for actual transmission of data. However, it must be done carefully by not releasing any sensitive information.

After establishing the key by using Algorithm 1 or Algorithm 2 for the case of reconfigurable antenna supported wireless cards, the secure transmission begins. Similar to Transmission Control Protocol (TCP)'s acknowledgements (ACKs), the protocol using the above algorithms keeps track of the ACKs and determines if the receiving end is able to understand the transmitter. If the ACKs are flowing without any issues, the inventors determine that the symmetric key was established without any problems and is now a valid key. However, if the ACKs are not received or a non-acknowledgement (NACK) was transmitted three times back to back, it is determined that the key generated was bad and the key generation step is repeated. This process is repeated until a valid key is established. The reason for repeating the transmission three times is because there is no need to regenerate the key due to a lost packet, which can happen in congested networks. The inventors try again to ensure the packet is not being acknowledged because of a key that was not generated as a symmetric key. Algorithm 3 summarizes this protocol for the transmitter.

Algorithm 3
Network Protocol using Symmetric Keys
from Wireless PHY Layer (Transmitter)

| | |
|---|---|
| 1: | N ∈ Z > 0 |
| 2: | generate key: |
| 3: | if wireless card equipped with RA then |
| 4: | M ← number of modes RA supports |
| 5: | key = generateSymmetricKeyW ithRA(N, M) |
| 6: | else |
| 7: | key = generateSymmetricKey(N) |
| 8: | communicate: |
| 9: | while 1 do |
| 10: | retryCount ← 0 |
| 11: | secureData = encryptData(data, key) |
| 12: | send(secureData) |
| 13: | waitFor(ACK) |
| 14: | retry: |
| 15: | if ACK not received or NACK received then |
| 16: | if retryCount < 2 then /** try to repeat it 3 times with a random |
| | back off time **/ |
| 17: | wait(randomTime) |
| 18: | send(secureData) |
| 19: | waitFor(ACK) |
| 20: | retryCount ++ |
| 21: | go to retry |
| 22: | else |
| 23: | go to generate key |
| 24: | if key expired then /** generate a new key when an old key is |
| | detected **/ |
| 25: | go to generate key |

Algorithm 4 demonstrates the functionality of the receiving end of the wireless communication. We train the receiver to send ACKs for all the packets it is able to decrypt without issues (e.g. checksum passes, or the Application layer reports valid data). For all packets, it receives and is not able to decrypt, it sends a NACK to indicate it received the packet but was unable to decrypt the packet. This can happen due to multiple reasons including a packet that was corrupted in-flight because of excessive interference. A repeated transmission with a short back off time might fix this error. Therefore, the transmitter treats the ACKs and NACKs the same. If three NACKs were sent back to back, a new key generation is triggered.

Algorithm 4
Network Protocol using Symmetric Keys
from Wireless PHY Layer (Receiver)

| | |
|---|---|
| 1: | N ∈ Z > 0 |
| 2: | generate key: |
| 3: | if wireless card equipped with RA then |
| 4: | M ← number of modes RA supports |
| 5: | key = generateSymmetricKeyW ithRA(N, M) |
| 6: | else |
| 7: | key = generateSymmetricKey(N) |
| 8: | communicate: |
| 9: | while 1 do |
| 10: | secureData = receive( ) |
| 11: | data = decryptData(secureData, key) |
| 12: | if data is meaningful then |
| 13: | send(ACK) |
| 14: | else |
| 15: | send(NACK) |

The algorithms described herein can be used in any of a number of devices that use symmetric encryption keys. For example, the algorithms described herein can be incorporated into wireless access points and the CSI in the local network can be used to automatically generate symmetric encryption keys without the user having to manually enter encryption keys. The symmetric encryption keys would be secure as they are based on the local environment, which is virtually impossible to replicate remotely. This approach can automatically secure the communications over open wireless networks (those without authentication or encryption) or closed wireless networks using other methods of authentication.

For example, in the case of multiple users connecting to an open network in a coffee shop, the algorithm would automatically generate unique symmetric encryption keys for each user and start securing their wireless communications. This automatically secures the mentioned open wireless network. At regular intervals and/or when a user moves (changing the environment), the algorithm regenerates the symmetric encryption keys to provide continued security without any interruption to the user.

It will be appreciated that the algorithms and methods described herein may be implemented in software that operates on a processor in a wireless access point such as those implemented in wireless routers, base stations, wireless cards, and the like, where the processor executes instructions stored in a memory component. The processor may include a standardized processor, a specialized processor, a microprocessor, or the like. The processor may execute instructions including, for example, instructions for implementing the method as described herein. On the other hand, the memory component stores the instructions that may be executed by the processor. The memory component may include a tangible computer readable storage medium in the form of volatile and/or nonvolatile memory such as random access memory (RAM), read only memory (ROM), cache, flash memory, a hard disk, or any other suitable storage component. In one embodiment, the memory component may be a separate component in communication with a processor, while in another embodiment, the memory component may be integrated into the processor. Such non-transitory memory components may be used as a computer readable storage device to store the instructions for implementing the methods and software features described herein.

Those skilled in the art also will readily appreciate that many additional modifications and scenarios are possible in the exemplary embodiment without materially departing from the novel teachings and advantages of the invention. Accordingly, any such modifications are intended to be included within the scope of this invention as defined by the following exemplary claims.

1.-18. (canceled)

19. A method of generating symmetric encryption keys, comprising:
for each data subcarrier of a plurality of data subcarriers at a transmitter or at a receiver,
sending data wirelessly between the transmitter and the receiver to generate channel trend information (CTI) data, representative of channel state information (CSI) data, wherein CSI data are collected from forward and backward channels between the transmitter and the receiver, and wherein the forward and backward channels are not identical,
determining, for each measurement of successive measurements taken from the collected CSI data, whether an increase or decrease in measurement magnitude from the previous measurement is observed,
generating the CTI data by assigning a first value for an increase in measurement magnitude and a second value for a decrease in measurement magnitude; and
using the CTI data, generated for each of the plurality of data subcarriers, to generate the symmetric encryption keys or as the symmetric encryption keys themselves.

20. The method of claim 19, further comprising:
after generating the CTI data, for each data subcarrier of the plurality of data subcarriers, by assigning the first value for an increase in measurement magnitude and the second value for a decrease in measurement magnitude, determining the most agreed upon value of the first and second values; and
using the most agreed upon value, determined for each of the subcarrier, to generate the symmetric encryption keys or as a key of the symmetric encryption keys themselves.

21. The method of claim 19, wherein at least one of the transmitter and receiver includes a reconfigurable antenna, wherein the reconfigurable antenna comprises at least one mode, further comprising generating CTI data for each data subcarrier of the plurality of data subcarriers and for each mode of each reconfigurable antenna, and using the generated CTI data to generate symmetric encryption keys or as the symmetric keys themselves.

22. The method of claim 19, wherein the data sent between the transmitter and the receiver to generate channel trend information (CTI) data comprises dummy data that does not contain important information from which symmetric key information may be learned.

23. The method of claim 19, further comprising initiating transmission using the generated symmetric keys, determining whether acknowledgements are not received or whether a non-acknowledgement has been received, and, if so, repeating the symmetric encryption key generation step until a valid symmetric key is established.

24. The method of claim 19, further comprising initiating transmission using the generated symmetric encryption keys, receiving acknowledgements for all packets from the transmitter that the receiver is able to decrypt, receiving non-acknowledgements for all packets from the transmitter that the receiver received and was unable to decrypt, determining whether acknowledgements or non-acknowledgements have been received, and, if so, repeating the symmetric encryption key generation step until a valid symmetric key is established.

25. A wireless access point that generates symmetric encryption keys for enabling wireless communications between a transmitter of the wireless access point and a receiver of a network node, comprising a memory that stores instructions for implementing a symmetric key generation algorithm and a processor that processes the stored instructions to implement the algorithm by performing the steps of:
sending data wirelessly between the transmitter and the receiver to generate channel trend information representative of channel state information collected from forward and backward channels between the transmitter and receiver, wherein the forward and backward channels are not identical;
repeating the process of sending data between the transmitter and receiver for each data subcarrier to generate channel trend information for each of a plurality of data subcarriers;
determining, for each data subcarrier, for successive channel state information data collected from forward and backward channels, whether an increase or decrease in magnitude from the previous measurement is observed for each of a plurality of data points and, if so, assigning a first value for an increase in magnitude and a second value for a decrease in magnitude; and
using the channel trend information for each data subcarrier to generate symmetric encryption keys or as the symmetric encryption keys themselves.

26. The wireless access point of claim 25, wherein the processor further executes instructions to perform the steps of collecting 2N measurements of channel state information to form the channel trend information, where N is an integer greater than 0 and repeating the steps of determining, for each data subcarrier, for successive channel state information data collected from forward and backward channels, whether an increase or decrease in magnitude from the previous measurement is observed for each data point and, if so, assigning a first value for an increase in magnitude and a second value for a decrease in magnitude to provide 2N−1 sets of the first values and the second values.

27. The wireless access point of claim 26, further comprising a pseudorandom generator, wherein the processor further executes instructions to perform the steps of determining the most agreed upon bit value and assigning the most agreed upon bit value as a key bit for the pseudorandom generator.

28. The wireless access point of claim 27, wherein the processor further executes instructions to perform the steps of repeating the steps of determining the most agreed upon bit value and assigning the most agreed upon bit value as the key bit for all of the data subcarriers to yield a key with length equal to a number of data subcarriers being used for the wireless transmission between the transmitter and the receiver.

29. The wireless access point of claim 25, wherein at least one of the transmitter and receiver includes a reconfigurable antenna, wherein the reconfigurable antenna comprises at least one mode, and wherein the processor further executes instructions to perform the steps of using the channel trend information for each data subcarrier for each mode of each reconfigurable antenna to generate symmetric encryption keys or as the symmetric encryption keys themselves.

30. The wireless access point of claim 26, wherein the data sent between the transmitter and the receiver comprises dummy data that does not contain important information from which symmetric key information may be learned.

31. The wireless access point of claim 26, wherein the processor further executes instructions to perform the steps of initiating transmission using the generated symmetric keys, determining whether acknowledgements are not received or a non-acknowledgement has been received at least three times back to back, and, if so, repeating the symmetric key generation step until a valid symmetric key is established.

32. The wireless access point of claim 26, wherein the processor further executes instructions to perform the steps of initiating transmission using the generated symmetric keys, receiving acknowledgements for all packets from the transmitter that the receiver is able to decrypt without issues, receiving non-acknowledgements for all packets from the transmitter that the receiver received and was unable to decrypt, determining whether acknowledgements or non-acknowledgements have been received at least three times back to back, and, if so, repeating the symmetric key generation step until a valid symmetric key is established.
